(19) United States
(12) Patent Application Publication
(10) Pub. No.: US 2018/0350308 A1
(43) Pub. Date: Dec. 6, 2018

(54) BACKLIGHT LUMINANCE CONTROL DEVICE, BACKLIGHT LUMINANCE CONTROL METHOD AND IMAGE DISPLAY DEVICE

(71) Applicants: QINGDAO HISENSE ELECTRONICS CO., LTD., QINGDAO (CN); HISENSE INTERNATIONAL CO., LTD., QINGDAO (CN); HISENSE USA CORPORATION, SUWANEE, GA (US)

(72) Inventor: YUXIN ZHANG, QINGDAO (CN)

(21) Appl. No.: 15/855,962

(22) Filed: Dec. 27, 2017

(30) Foreign Application Priority Data
Jun. 1, 2017 (CN) 201710404396.X
Jun. 1, 2017 (CN) 201710404397.4

(51) Int. Cl. G09G 3/34

(52) U.S. Cl. CPC G09G 3/342; G09G 2320/062; G09G 2320/064

(57) ABSTRACT

The present application provides a backlight luminance control device, a backlight luminance control method and an image display device, which belong to the field of display technologies, including: an image processor, a master backlight controller connected to the image processor, a plurality of slave backlight controllers respectively connected to the master backlight controller, and a pulse width modulation (PWM) driver, where each of the plurality of slave backlight controllers is configured to control backlight luminance of a corresponding extended partition, each of the corresponding extended partitions includes one or more backlight partitions, corresponding extended partitions of the respective slave backlight controllers are different; and each of the slave backlight controllers is connected to one or more PWM drivers.

### CROSS-REFERENCE TO RELATED APPLICATIONS

The present application claims priorities to the following patent applications submitted to the Chinese Intellectual Property Office, Chinese Patent Application No. 201710404397.4, filed on Jun. 1, 2017 and entitled “BACKLIGHT LUMINANCE CONTROL DEVICE AND IMAGE DISPLAY DEVICE”; and CN Patent Application No. 201710404396.X, filed on Jun. 1, 2017 and entitled “BACKLIGHT LUMINANCE CONTROL DEVICE AND IMAGE DISPLAY DEVICE”, both of which are hereby incorporated by reference in their entireties.

### TECHNICAL FIELD

The present application relates to the field of display technologies and, in particular, to a backlight luminance control device, a backlight luminance control method and an image display device.

### BACKGROUND

In prior art, when an image display device is controlling backlight luminance, pieces of partition backlight data having one-to-one correspondences with respective backlight partitions are generated by an image processor, the partition backlight data is distributed to a backlight processing unit, backlight control signals are then generated by the backlight processing unit, and respective pulse width modulation (PWM) drivers are controlled through the backlight control signals to drive backlights connected to the respective PWM drivers. However, when there are more and more backlight partitions, such as up to hundreds of partitions or thousands of partitions, it is desired to realize a parallel control of luminance of a backlight corresponding to each backlight partition. Therefore, there are many control cables connected to the backlights such as LED lamps.

### SUMMARY

The present application provides a backlight luminance control device, a backlight luminance control method and an image display device, which may ensure the integrity and accuracy of transmission of each piece of partitioned backlight frame data communicated between an image processing chip and a backlight controller.

In a first aspect, the present application provides a backlight luminance control device, including: an image processor, a master backlight controller connected to the image processor, a plurality of slave backlight controllers respectively connected to the master backlight controller, and a pulse width modulation (PWM) driver, where each of the plurality of slave backlight controllers is configured to control backlight luminance of a corresponding extended partition, each of the corresponding extended partitions comprises one or more backlight partitions, corresponding extended partitions of the respective slave backlight controllers are different; and each of the slave backlight controllers is connected to one or more PWM drivers;

the image processor is configured to: based on a received image signal, obtain pieces of partition backlight data according to a predetermined partitioning algorithm and transmit the pieces of partition backlight data to the master backlight controller, where the partition backlight data is used to characterize luminance information of a partition image;

the master backlight controller is configured to: receive the pieces of partition backlight data; obtain a global backlight value according to the received pieces of partition backlight data; transmit the global backlight value to the plurality of slave backlight controllers and distribute the partition backlight data of the corresponding extended partitions of the respective slave backlight controllers to the respective slave backlight controllers, where the global backlight value is used to characterize overall luminance information of the image signal;

each of the plurality of slave backlight controllers is configured to: receive the global backlight value distributed by the master backlight controller and the partition backlight data of the corresponding extended partition; determine, according to the global backlight value and a preset mapping relationship, a peak gain coefficient mapped by the global backlight value; determine, according to the peak gain coefficient and the partition backlight data, gained partition backlight data of the extended partition, and output a control signal according to the gained partition backlight data of the extended partition, where the preset mapping relationship is a corresponding relationship between global backlight values and peak gain coefficients; and

the one or more PWM drivers are controlled in parallel by each of the slave backlight controllers, configured to receive the control signal and control backlights of the extended partition corresponding to the slave backlight controller.

In a second aspect, the present application provides a backlight luminance control method, comprising:

obtaining, by an image processor, pieces of partition backlight data according to a predetermined partitioning algorithm based on a received image signal, and sending the pieces of partition backlight data to a master backlight controller, wherein the partition backlight data is used to characterize luminance information of a partition image;

receiving, by the master backlight controller, the pieces of partition backlight data, and obtaining a global backlight value according to the received pieces of partition backlight data, wherein the global backlight value is used to characterize overall luminance information of the image signal;

sending, by the master backlight controller, the global backlight value to a slave backlight controller, and distributing the partition backlight data of a corresponding extended partition of the slave backlight controller to the slave backlight controller, wherein, the extended partition comprises one or more backlight partitions, corresponding extended partitions of different slave backlight controllers are different;

receiving, by the slave backlight controller, the global backlight value distributed by the master backlight controller and the partition backlight data of the corresponding extended partition; and determining a peak gain coefficient according to the global backlight value and a preset mapping relationship, wherein the preset mapping relationship is a corresponding relationship between global backlight values and peak gain coefficients;

determining, by the slave backlight controller, gained partition backlight data of the extended partition according to the peak gain coefficient and the partition backlight data, and outputting a control signal according to the gained partition backlight data for controlling backlight of the extended partition.

In a third aspect, the present application provides an image display device, including: a display panel, a backlight assembly, and the backlight luminance control device described above.

### BRIEF DESCRIPTION OF DRAWINGS

In order to make technical solutions in embodiments of the present application or the prior art clearer, accompanying drawings used in the description of the embodiments or the prior art will be briefly described hereunder. Obviously, the described drawings are merely some embodiments of present application. For persons skilled in the art, other drawings may be obtained based on these drawings without any creative effort.

FIG. 1 is a schematic structural diagram of an image display device according to some embodiments of the present application;

FIG. 2 is a schematic diagram of backlight partitions according to some embodiments of the present application;

FIG. 3 is a schematic structural diagram of a backlight driving unit according to some embodiments of the present application;

FIG. 4a-FIG. 4c are schematic diagrams of divisions of three different kinds of extended partitions according to some embodiments of the present application;

FIG. 5 is a schematic diagram of data transmission between an image processor and a master backlight controller according to some embodiments of the present application;

FIG. 6 is a schematic diagram of data transmission between the master backlight controller and slave backlight controllers according to some embodiments of the present application;

FIG. 7a is a first flow chart of a backlight data algorithm of the master backlight controller according to some embodiments of the present application;

FIG. 7b is a second flow chart of a backlight data algorithm of the master backlight controller according to some embodiments of the present application;

FIG. 8a is a schematic flow chart of a backlight data algorithm of a slave backlight controller according to some embodiments of the present application;

FIG. 8b is a curve showing a relationship between global backlight values and peak gain coefficients according to some embodiments of the present application;

FIG. 9a is a schematic diagram of data transmission between the image processor and the master backlight controller according to some embodiments of the present application; and

FIG. 9b is a schematic diagram of a data timing of an SPI bus according to some embodiments of the present application.

### DESCRIPTION OF EMBODIMENTS

The technical solutions in the embodiments of the present application will be described hereunder clearly and completely with reference to the accompanying drawings in the embodiments of the present application. Obviously, the described embodiments are only a part of embodiments of the present application, rather than all embodiments of the present application. All other embodiments obtained by persons of ordinary skill in the art based on the embodiments of the present application without any creative effort should fall into the protection scope of the present application.

Hereinafter, the technical solutions shown in the present application will be described in detail through specific embodiments. It should be noted that the following specific embodiments may be combined with each other. For the same or similar concepts or procedures, details will not be repeated in some embodiments.

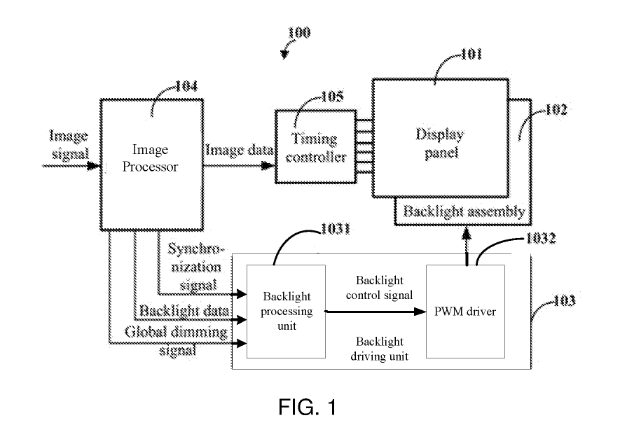

FIG. 1 is a schematic structural diagram of an image display device according to some embodiments of the present application. The image display device 100 includes a backlight luminance control device, a display panel 101, a backlight assembly 102 and a timing controller 105. The backlight luminance control device may include a backlight driving unit 103 and an image processor 104.

The backlight assembly 102 includes a plurality of backlights, which may respectively adjust luminance of the backlights according to backlight driving control signals from the backlight driving unit 103, where the backlights may be a light emitting diode (LED) or other light-emitting elements. The backlight assembly 102 may be divided into a plurality of backlight partitions by each backlight correspondingly, where the backlight partitions may emit light of different luminance and perform optical modulations through the display panel 101 disposed thereon to form a display image. Each backlight partition may correspond to a partition image, and the backlight partitions may have a one-to-one correspondence with the partition images. The partition images may be obtained by dividing an image to be displayed. The image to be displayed refers to an image which is used to be displayed on the liquid display panel 101. Division of the partition images occurs during image processing. When the image to be displayed is displayed on the liquid crystal panel, there may be no division between the partition images.

The backlight driving unit 103 includes a backlight processing unit 1031 with a processor function and a PWM driver 1032. The PWM driver 1032 and the timing controller 105 may be implemented by using related devices in the related art, for which details will not be repeated. Working principles of the backlight processing unit 1031 and the image processor 104 will be respectively described in detail below.

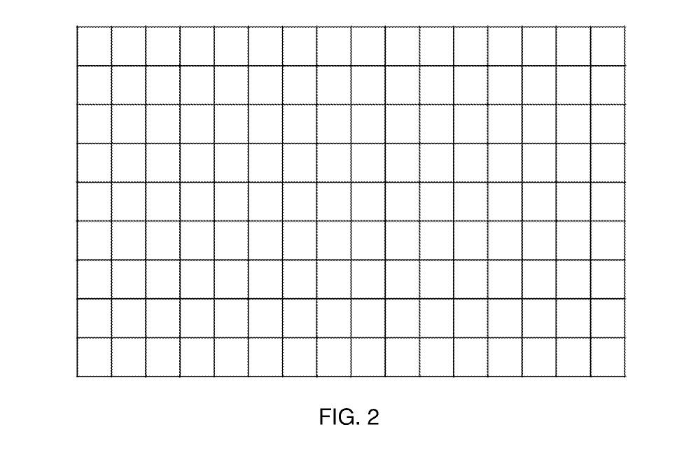

FIG. 2 is a schematic diagram of backlight partitions according to some embodiments of the present application. One backlight partition may corresponds to one backlight, in which one or more light sources may be configured, where the light source herein may be an LED light source or other light-emitting elements. The backlight partitions may be equally divided or may be unequally divided if necessary, and the backlight partitions may be disposed in a manner where there is an overlapping portion between the backlight partitions. As described above, since the partition images obtained by dividing the image to be displayed have a one-to-one correspondence with the backlight partitions, specific dividing methods are not limited herein for the backlight partitions and the partition images, providing that both of them need to be mutually corresponding in size, position, etc. As there are more and more backlight partitions describe above, such as hundreds of partitions or thousands of partitions and even more, a parallel control mode may cause the system to be extremely complicated, there are many light source driving cables. To solve this problem, the backlight driving unit 103 is optimized in the embodiments of the present application.

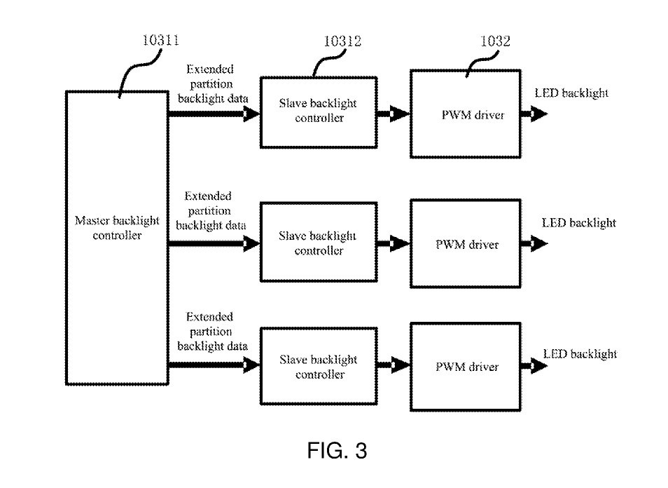

FIG. 3 is a schematic structural diagram of a backlight driving unit according to some embodiments of the present application. The backlight driving unit 103 includes a master backlight controller 10311, a plurality of slave backlight controllers 10312, and a plurality of PWM drivers 1032 respectively controlled by the plurality of slave backlight controllers. Among them, each slave backlight controller 10312 may control one PWM driver 1032, or may control a plurality of PWM drivers 1032. Each PWM driver 1032 corresponds to one or more backlights. The plurality of slave backlight controllers are controlled in parallel, and a plurality of PWM drivers of a slave backlight controller are also controlled in parallel. The one or more PWM drivers controlled by a slave backlight controller are configured to receive a control signal sent by said slave backlight controller and control backlights of the extended partition corresponding to said slave backlight controller. It should be noted that the number of the slave backlight controllers and the number of the PWM drivers in the drawing are only examples, but limitation is not made thereto. The control of the PWM drivers from the slave backlight controllers is the same as the control of the PWM driver from the backlight processing unit in the prior art, but details will not be repeated herein.

The master backlight controller 10311 may receive pieces of partition backlight data from the image processor 104. The pieces of partition backlight data are obtained by the image processor 104 according to a predetermined partitioning algorithm based on an image signal it receives. Each piece of partition backlight data is used to characterize luminance information of partition images corresponding to respective backlight partitions, for its acquiring manner, description will be made hereinafter in detail.

Since the backlight partitions have a one-to-one correspondence with the partition images, the number of the pieces of partition backlight data generated by the image processor 104 is the same as the number of backlight partitions. All the backlight partitions may be divided into a plurality of extended partitions, each slave backlight controller controls backlight luminance of all the backlight partitions in one extended partition, thus the master backlight controller may divide all the partition backlight data into a plurality of extended partition packets, and distribute same to the plurality of slave backlight controllers, that is, only transmit, to an individual slave backlight controller, partition backlight data of an extended partition controlled by the slave backlight controller, i.e., partition backlight data corresponding to all backlight partitions in the extended partition, and each slave backlight controller only needs to receive the partition backlight data of the extended partition under its control, thus each slave controller and at least one PWM driver corresponding thereto may be disposed on a driving circuit board, amounting position of the driving circuit board on a backplane is relatively close to a position of the extended partition in a module, such that fewer and shorter control lines are required when each slave backlight controller controls a backlight in a corresponding extended partition.

In addition, the master backlight controller 10311 may also receive a synchronization signal from the image processor 104. The synchronization signal is used for synchronization between the image processor 104 and the backlight processing unit 1031, such that the master backlight controller 10311 learns where a current frame of partition backlight data starts in order to avoid misplacement.

In some implementations provided in the present application, the master backlight controller 10311 may also receive a global dimming signal from the image processor 104 when global dimming needs to be performed on the image to be displayed. The global dimming signal is used to make an overall adjustment to the image to be displayed, which may be information obtained by the image processor 104 according to an input adjustment from a user, a backlight mode selection or a combination of ambient light factors or the like, and is transmitted to the master backlight controller 10311 in a form of signal. For instance, information generally required to be carried in the global dimming signal is a percentage value, then, as a possible implementation, a PWM signal may be implemented as the global dimming signal, such that the backlight processing unit 1031 may attain the above percentage value from a duty cycle of the PWM signal. The master backlight controller 10311 will transmit information about the duty cycle to the slave backlight controllers 10312 respectively, and the slave controllers 10312 control backlights based on the information about the duty cycle. As another way, the master backlight controller 10311 does not acquire the global dimming signal from the image processor 104, but calculates global backlight luminance according to all pieces of received partition backlight data and generates the duty cycle of the PWM signal or a duty cycle of a preset PWM signal based on this.

The image processor 104 receives an image signal, where the image signal characterizes relevant information of the image to be displayed that needs to be displayed on the display panel 101. After receiving the image signal, the image processor 104 will perform the following two operations: on one hand, decode the received image signal to generate image data and transmit same to the timing controller 105 or, if necessary, transform and correct the image signal, since transformation adjustment to the image signal is within the scope of the prior art, thus details will not be repeated in the embodiments of the present application; on the other hand, the image processor 104 will also obtain the synchronization signal and each piece of partition backlight data as described above from the image signal. Each piece of partition backlight data is used to characterize luminance information of a corresponding partition image of an individual backlight partition, which may be obtained by a gray scale algorithm according to an image signal of the corresponding partition image. For instance, since an image signal of a partition image may reflect pixel information of respective pixels of the partition image, luminance information of the partition image may be obtained by means of weighted processing according to an average value of pixel values of respective pixels of the partition image and the maximum value in the pixel values, thus the corresponding partition backlight data is obtained. Certainly, the algorithm herein is only an example, but limitation is not made thereto.

In an implementation provided in the present application, the image processor 104 will also generate a global dimming signal according to the partition backlight data.

The image processor 104 may output each piece of partition backlight data, the synchronization signal and the global dimming signal (if included) to the backlight processing unit 1031 in the backlight driving unit 103, rendering that the backlight processing unit 1031 outputs a backlight control signal to drive PWM drivers 1032 and the PWM drivers 1032 output backlight driving signals to control luminance of backlights of the backlight partitions.

In some embodiments, the above image processor 104 is generally a master processing chip of an image display device, such as a system on chip (SOC) chip or other video processing chips or the like.

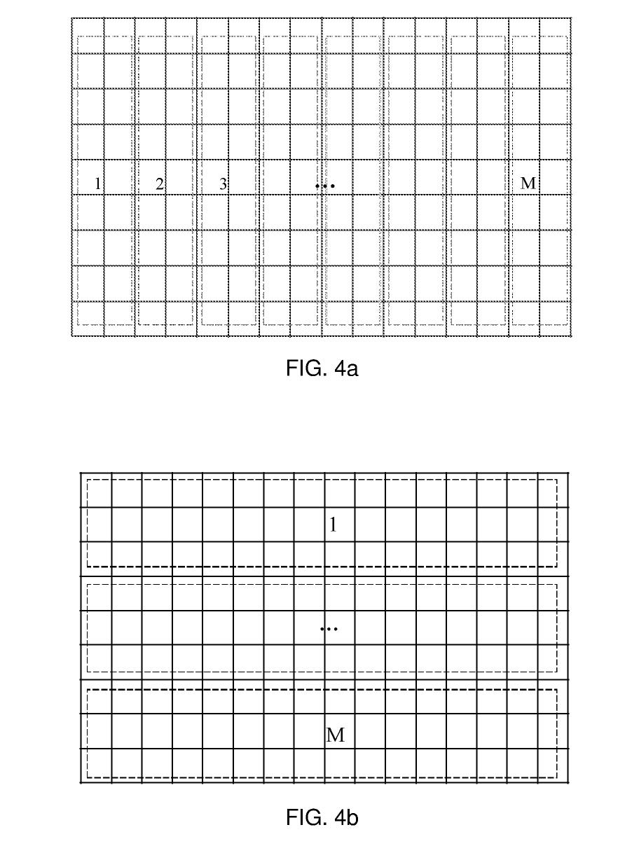

As shown in FIG. 2, assuming that there are M*N backlight partitions, where M and N respectively represent the number of rows and columns of the backlight partitions, then these backlight partitions will correspondingly have Data1-DataM*N pieces of partition backlight data, which respectively represent respective partition backlight data of the M*N backlight partitions. We may divide the M*N backlight partitions into a plurality of extended partitions. FIG. 4a-FIG. 4c are schematic diagrams of divisions of three different extended partitions provided on the basis of FIG. 2. The M*N backlight partitions may be divided into M extended partitions in a row or column manner, and each extended partition includes N backlight partitions. At this point, M slave backlight controllers may be set, each of which controls N backlight partitions. When the master backlight controller 10311 receives Data1-DataM*N pieces of partition backlight data from the image processor 104, it may distribute these pieces of partition backlight data to M slave backlight controllers after processing them, each slave backlight controller receives N pieces of partition backlight data from the master backlight controller.

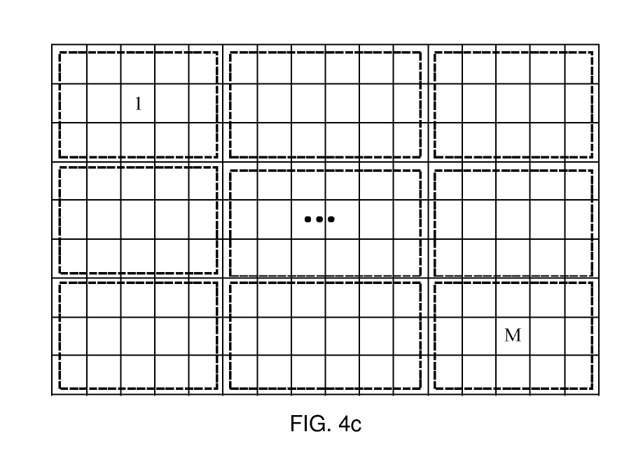

FIG. 5 shows a schematic diagram of data transmission between an image processor and a master backlight controller according to some embodiments of the present application. A timing relationship between a synchronization signal SYNC and pieces of partition backlight data on an SPI bus is described in FIG. 5. Data1-DataM*N respectively represent respective partition backlight data of M*N backlight partitions. It can be seen that the master backlight controller 10311 may start to receive the partition backlight data according to the synchronization signal.

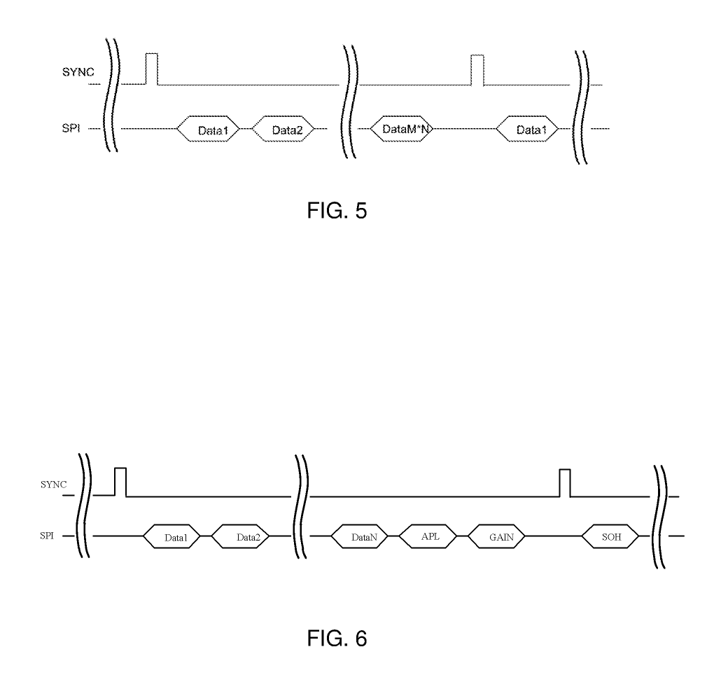

FIG. 6 shows a schematic diagram of data transmission between the master backlight controller and the slave backlight controllers according to some embodiments of the present application. Since each slave backlight controller may control luminance of N partition backlights, N pieces of partition backlight data Data1-DataN are included in an extended partition packet communicated between the master backlight controller and each of the plurality of slave backlight controllers.

It can be seen that, through the foregoing way of distinguishing the master backlight controller from the slave backlight controllers, after receiving respective pieces of partition backlight data transmitted by the image processor, the master backlight controller may divide, according to a corresponding relationship between the backlight partitions and the slave controllers, the respective pieces of partition backlight data into extended partition packets corresponding to extended partitions controlled by the plurality of slave backlight controllers, of which each extended partition packet only includes a portion of partition backlight data, that is, only includes partition backlight data of a backlight partition corresponding to at least one driving chip under control of an individual slave controller, so as to control a backlight corresponding to an individual extended partition.

In some implementations provided in the present application, in order to enable the image display device to obtain a better display effect and achieve a purpose of a global peak gain, the master backlight controller may be configured to statistically obtain a global backlight value based on the received respective pieces of partition backlight data; the slave backlight controller is configured to determine a peak gain coefficient corresponding to the global backlight value according to the global backlight value from the master backlight controller and a preset mapping relationship between global backlight values and peak gain coefficients, and output partition backlight data subjected to a peak gain.

The global backlight value is used to characterize luminance distribution properties of one or more frames of image signal, for instance, it may be an average picture level (APL) shown in the drawing. In a possible implementation, the foregoing global backlight value may be obtained by an averaging algorithm based on the respective pieces of partition backlight data. In another possible implementation, the global backlight value may also be obtained by other algorithms (such as in a manner of histogram statistics) according to distribution properties of overall luminance of all partition images. Different peak gains under different luminance distributions may be obtained through the mapping relationship between the global backlight values and the peak gain coefficients, under an architecture proposed in the present application where the master backlight controller controls the slave backlight controllers, since a slave controller receives an extended partition packet, that is, a portion of partition backlight data, calculation of the global backlight value cannot be performed, calculating the global backlight value in the master backlight controller may also reduce processing burdens on the slave backlight processors, which in turn makes it possible to use backlight processors with low processing capacities as the slave backlight controllers.

A processing flow between the master backlight controller and the slave backlight controllers will be descripted hereunder in detail with reference to the accompanying drawings.

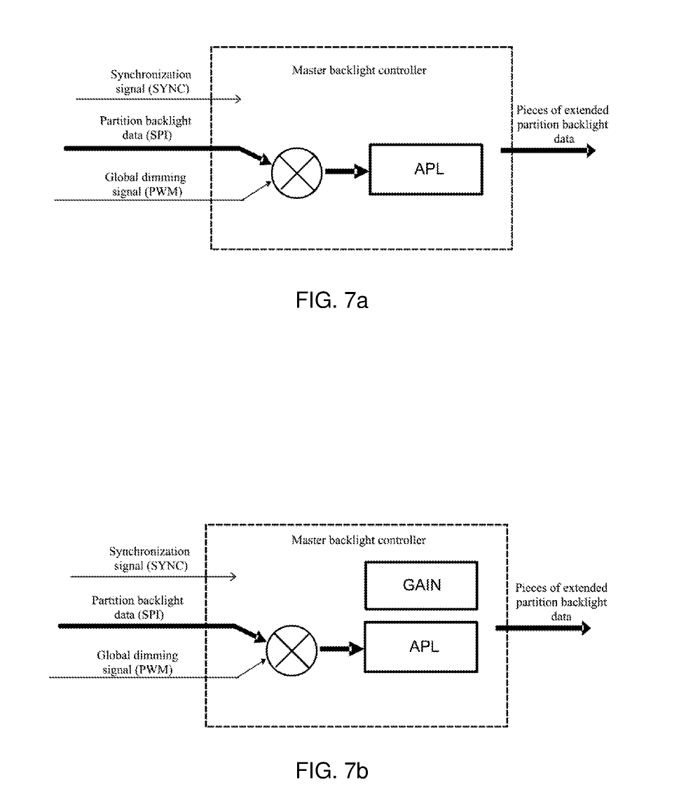

In some embodiments, FIG. 7a is a schematic flow chart of an algorithm of the master backlight controller according to some embodiments of the present application. It can be seen from the above description that the master backlight controller may receive the respective pieces of partition backlight data and the synchronization signal (SYNC) from the image processor 104, and may or may not include the global dimming signal.

When signals received by the master backlight controller 10311 from the image processor 104 include the global dimming signal, as a possible implementation, the master backlight controller 10311 may complete a weighted calculation according to the global dimming signal and the respective pieces of partition backlight data, and then statistically obtain the global backlight value according to results of the weighted calculation, for instance, in some embodiments, the global dimming signal may be a PWM signal, in that case, the master backlight controller 10311 may obtain, according to the PWM signal, information carried in the global dimming signal, that is, a percentage value, and then multiply the percentage value by the respective pieces of partition backlight data respectively to obtain pieces of partition backlight data subjected to global dimming, after that, these pieces of partition backlight data subjected to global dimming are statistically averaged to obtain the global backlight value. As another possible implementation, the master backlight controller 10311 may also obtain a statically-averaged backlight value according to a statistical average of the respective pieces of partition backlight data first, which then obtain, according to the global dimming signal and the statistically-averaged backlight value, the global backlight value by completing a product calculation, and meanwhile respectively multiply the above percentage value by the respective pieces of partition backlight data to obtain pieces of partition backlight data subjected to global dimming. The global dimming signal herein may be selected based on a backlight luminance adjustment from the user.

After that, the master backlight controller 10311 distributes the respective pieces of partition backlight data subjected to global dimming and the calculated global backlight value to a plurality of different slave backlight controllers 10312.

In another implementation, signals received by the master backlight controller 10311 from the image processor 104 may not include the global dimming signal. In this case, the global backlight value is calculated in a manner similar to the calculation method in the described case where the global dimming signal is included, that is, the global backlight value may be obtained, providing that only a statistical average needs to be performed on the respective pieces of partition backlight data inputted to the master backlight controller 10311, that is to say, when signals received by the master backlight controller 10311 from the image processor 104 include the global dimming signal, the pieces of partition backlight data output from the slave backlight controllers 10312 are pieces of partition backlight data subjected to global dimming; when signals received by the master backlight controller 10311 from the image processor 104 do not include the global dimming signal, the pieces of partition backlight data output from the slave backlight controllers 10312 are the same as the data inputted to the master backlight controller 10311.

Further in some embodiments, FIG. 7b is a schematic flow chart of an algorithm of the master backlight controller according to some embodiments of the present application. FIG. 7b is different from FIG. 7a in that the master backlight controller in FIG. 7b is further configured to obtain a preset adjustment coefficient GAIN based on FIG. 7a, where the adjustment coefficient GAIN may be associated with factors such as an ambient lightness parameter or a backlight mode or the like, rendering that the slave backlight controllers adjust the respective pieces of partition backlight data according to the adjustment coefficient GAIN after obtaining the adjustment coefficient GAIN. In addition to making the GAIN obtainable in a preset manner, as a feasible implementation, the master backlight controller may also obtain the GAIN by receiving a gain adjusting signal, where the gain adjusting signal carries the GAIN, the master backlight controller, after obtaining the GAIN from the gain adjusting signal, may transmit same to the plurality of slave backlight controllers. It should be noted that the GAIN may be a value determined based on a backlight mode, in the backlight mode with the GAIN value determined, the user may also further select a backlight luminance adjustment factor, and the backlight luminance adjustment factor may be carried by the global dimming signal described above. In other words, if there area global dimming signal and a gain adjusting signal, then pieces of partition backlight data will be adjusted in the master backlight controller once and will be adjusted in the slave backlight controllers by the GAIN once again later; if there is only a gain adjusting signal but without a global dimming signal, then the pieces of partition backlight data will be adjusted in the slave backlight controllers by the GAIN once again, at this point, the gain adjusting signal may be achieved by an implementation the same as that of the global dimming signal.

After that, the master backlight controller 10311 may distribute, to a plurality of different slave backlight controllers 10312, the respective pieces of partition backlight data and the global backlight value together with the adjustment coefficient GAIN if included. As shown in FIG. 6, based on this, the extended partition data packets (that is, the pieces of partition backlight data of the corresponding extended partitions of the respective slave backlight controllers), the APL and the adjustment coefficient GAIN may be transmitted to the slave backlight controllers 10312. Since the master backlight controller is connected with a plurality of slave backlight controllers, it needs to transmit, to each slave backlight controller, partition backlight data of backlight partitions corresponding to an extended partition controlled by the slave backlight controller, the global backlight value and the adjustment coefficient GAIN. In some embodiments, the master backlight controller may also transmit synchronization signals to the slave backlight controllers in order to avoid data reception misplacement.

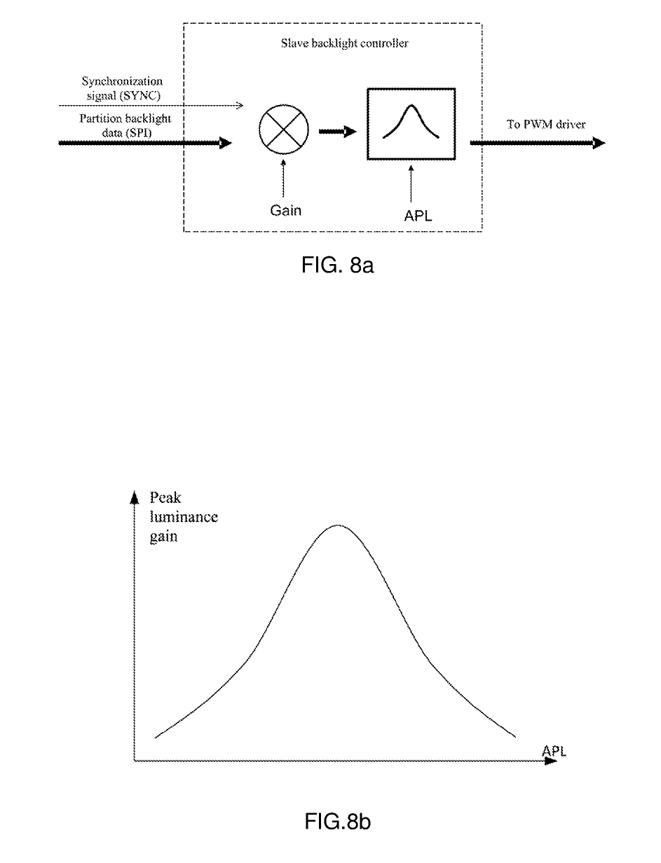

FIG. 8a is a schematic flow chart of an algorithm of a slave backlight controller according to some embodiments of the present application. A slave backlight controller 10312 obtains, according to the received global backlight value and a mapping relationship between global backlight values and peak gain coefficients preset in the slave backlight controller 10312, a peak gain coefficient corresponding to the global backlight value. According to the obtained peak gain coefficient, the slave backlight control may output gained partition backlight data of an extended partition under its control, where the preset mapping relationship may be a look-up table of a corresponding relationship between the global backlight values and the peak gain coefficients, such as a curve showing a relationship between the global backlight values and the peak gain coefficients as shown in FIG. 8b.

In some embodiments, tables with different mapping relationships may be preset in different slave backlight controllers corresponding to different extended partitions. In some embodiments, the peak gain coefficients in the mapping relationship curves are different according to regional distributions of different extended partitions. Taking FIG. 8b as an example, it can be seen that the relationship between APLs and peak gain coefficients is substantially: as an APL is increased, a peak gain coefficient is also increased continuously, both of them have a positive correlation; when the APL is increased to a certain extent, the peak gain coefficient reaches a maximum value; after that, as the APL increases, the peak gain coefficient will become smaller, that is, they start to have a negative correlation. Curves with different mapping relationships may be preset in different slave backlight controllers, for instance, taking FIG. 4a as an example, relatively sharp mapping relationship curves are provided for controlling slave backlight controllers with extended partitions in proximity to the middle, in contrast, smooth mapping relationship curves are provided for controlling slave backlight controllers with extended partitions in proximity to edges, in this way, although APLs of all slave backlight controllers are the same, the extended partitions in proximity to the middle will be relatively bright, while the extended partitions in proximity to the edges will be relatively dark, thereby producing a more visually stereoscopic effect.

Each of the plurality of slave backlight controllers respectively multiplies pieces of partition backlight data corresponding to respective backlight partitions in the received extended partition packet by the peak gain coefficient obtained according to the global backlight value, and outputs pieces of partition backlight data subjected to a peak gain to generate signals used for controlling luminance of backlights of the corresponding backlight partitions, thereby achieving a peak luminance gain for the respective backlight partitions and an increase in the maximum backlight luminance for the respective backlight partitions.

In some embodiments, if the received extended partition packet also includes an adjustment coefficient GAIN field, then a gain operation of multiplying the respective pieces of partition backlight data with the adjustment coefficient GAIN may be performed. Certainly, the GAIN gain operation may be before the peak gain or after the peak gain.

After the above peak gain or the GAIN gain operation, obtain pieces of partition backlight data subjected to the peak gain, and output same to one or more PWM drivers controlled by each of the plurality of slave backlight controllers.

Thus, the master backlight controller transmits the global backlight value to the slave backlight controllers, and a peak gain adjustment is performed by each slave backlight controller according to a table about global backlight values and peak gains it preset, respectively, thereby making it possible to achieve the purpose that the respective slave backlight controllers perform the peak gain adjustments respectively, in this case, the image is processed more flexibly.

In some implementations, the master backlight controller is disposed on a master backlight control circuit board for which peripheral circuits are configured, where the master backlight control circuit board is connected to a plurality of slave backlight controllers corresponding to respective extended partitions via a plurality of serial buses, thus M extended partitions may be achieved providing that only M control buses are needed. In addition, each extended partition is correspondingly arranged with a slave backlight controller, and a plurality of slave backlight controllers are achieved by being respectively disposed on a plurality of circuit boards with driving circuits configured, where a circuit board of a driving circuit includes a slave backlight controller and one or more PWM drivers. The slave backlight controller respectively controls one or more backlight drivers to drive respective LED backlights to be turned on or turned off in order to achieve the purpose of controlling luminance of the respective backlights. Thus, fewer and shorter control lines are required when each slave backlight controller controls backlights in a corresponding extended partition.

In related art, only one backlight controller is provided; one end of each of light source driving lines between backlight partitions and the backlight controller is connected to a circuit board where the backlight controller is located, and the other end of each of the light source driving lines is connected to a corresponding backlight partition, this architecture causes the circuit board where the backlight controller is located to be connected with dense light source driving lines, moreover, the positions of the backlights of the respective backlight partitions are fixed, and the position of the circuit board where the backlight controller is located is also fixed, this requires to provide light source driving lines with different lengths on the circuit board where the backlight controller is located in order to meet requirements of the backlight driving.

Working principles of the master backlight controller 10311 and the slave backlight controllers 10312 in the backlight processing unit 103 are described above in detail. Pieces of partition backlight data are transmitted from the image processor 104 to the master backlight controller 10311, and then transmitted to the slave backlight controllers 11312 after being processed by the master backlight controller 10311. As mentioned above, since there are hundreds of or thousands of backlight partitions, the amount of the pieces of partition backlight data may be up to more than one thousand, rendering that each frame of backlight data has extremely large amount of data, a fast system transmission rate and a powerful decoding capacity are required, and a data error phenomenon is prone to occur. Therefore, the embodiments of the present application provide a data transmission mode to ensure accuracy of data transmission between units by adding a field with a check function after the transmitted partition backlight data. This transmission mode is applicable not only between the image processor and the master backlight controller, but also between the master backlight controller and the slave backlight controllers. In these two circumstances, only data transmitted may be different, but the field with the check function is added to the data in similar manners, thus only the data transmission between the image processor and the master backlight controller is described as an example herein.

The slave controllers may be placed on driving boards, which solves the problem of excessively dense wiring on the same board; moreover, since a setting position of a driving board may be adjusted, distance between the driving board and a light bar is reduced, and lengths of lines used are reduced.

From a perspective of a communication manner between the image processor 104 and the master backlight controller 10311, first, in terms of a connection manner, the master backlight controller 10311 may be connected to the image processor 104 via a serial bus. The serial bus herein may be a serial peripheral interface (SPI) bus or the like, for instance.

Then, from a perspective of data transmission, the image processor 104 needs to transmit respective pieces of partition backlight data, a synchronization signal and a global dimming signal to the master backlight controller 10311, corresponding to the connection mode, the master backlight controller 10311 may receive the respective pieces of partition backlight data, the global dimming signal and the synchronization signal SYNC from the image processor 104 via the serial bus.

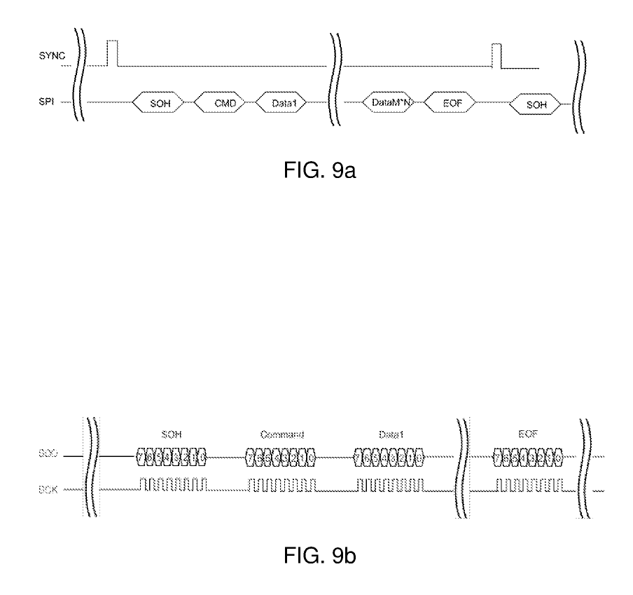

FIG. 9a is a schematic diagram of data transmission between the image processor and the master backlight controller according to some embodiments of the present application. A timing relationship between the synchronization signal SYNC and the pieces of partition backlight data on an SPI bus is described in FIG. 9a. FIG. 9b is a schematic diagram of a data timing of the SPI bus according to some embodiments of the present application. Compared to FIG. 5, in order to ensure the integrity and accuracy of data of a communication frame, an end of frame (EOF) used for indicating an end of frame data may be included after pieces of partition backlight data Data1-DataM*N. The EOF may be a preset fixed number or a checksum of all pieces of data in a current frame used for frame check. In order to ensure the accuracy of a frame of data, when the EOF is the checksum, if there is a decoding error of an individual piece of data in the frame of data, then check bytes are not correct, all the data in the frame may be discarded to prevent the individual piece of data from being undetected due to damages during transmission, to avoid introduction of pieces of wrong partition backlight data, thereby further increasing the check accuracy.

In some embodiments, two sections may be further included before the pieces of partition backlight data Data1-DataM*N, one of which is a start of heading (SOH) used for indicating a start of frame data, preventing the pieces of partition backlight data of a plurality of backlight partitions from misplacement in order to ensure the integrity and accuracy of each frame of partitioned backlight data; the other of which is a command field (Command, CMD), where the CMD is a reserved command byte used to communicate an instruction transmitted from the image processor 104, such as some driving mode selection instructions, enabling instructions and the like, for instance, the adjustment gain GAIN mentioned above may be transmitted to the master backlight controller by the image processor using the CMD. It should be noted that all the bytes in the illustrations are represented in 8 bits, which is only an example, limitations are not made thereto. In practice, a decision may be made according to the precision of the controllers.

In some embodiments provided in the present application, by way of the master controller controlling the slave controllers, pieces of partition backlight data corresponding to extended partitions are repackaged in the master controller and respectively distributed to corresponding slave controllers, since the master controller may perform a check on the pieces of partition backlight data, such that the pieces of backlight data received by the slave controllers are more accurate.

In some embodiments, the present application provides a backlight luminance control method, the method may be implemented by the backlight luminance control device described above. The method may include the following steps:

an image processor obtains pieces of partition backlight data according to a predetermined partitioning algorithm based on a received image signal, and sends the pieces of partition backlight data to a master backlight controller, wherein the partition backlight data is used to characterize luminance information of a partition image;

the master backlight controller receives the pieces of partition backlight data, and obtains a global backlight value according to the received pieces of partition backlight data, wherein the global backlight value is used to characterize overall luminance information of the image signal;

the master backlight controller sends the global backlight value to a slave backlight controller, and distributes the partition backlight data of a corresponding extended partition of the slave backlight controller to the slave backlight controller, wherein, the extended partition includes one or more backlight partitions, corresponding extended partitions of different slave backlight controllers are different;

the slave backlight controller receives the global backlight value distributed by the master backlight controller and the partition backlight data of the corresponding extended partition; and determines a peak gain coefficient according to the global backlight value and a preset mapping relationship, wherein the preset mapping relationship is a corresponding relationship between global backlight values and peak gain coefficients;

the slave backlight controller determines gained partition backlight data of the extended partition according to the peak gain coefficient and the partition backlight data, and outputs a control signal according to the gained partition backlight data for controlling backlight of the extended partition.

The purpose, the technical solutions and the beneficial effects of the present application are further described in detail in the above specific embodiments. It will be appreciated that the above description is only specific embodiments of the present application, and it is not intended to limit the protection scope of the present application. Any modifications, equivalent replacements or improvements made within the spirit and the principle of the present application should be included in the protection scope of the present application.

What is claimed is:

1. A backlight luminance control device, comprising: an image processor, a master backlight controller connected to the image processor, a plurality of slave backlight controllers respectively connected to the master backlight controller, and a pulse width modulation (PWM) driver, wherein each of the plurality of slave backlight controllers is configured to control backlight luminance of a corresponding extended partition, each of the corresponding extended partitions comprises one or more backlight partitions, corresponding extended partitions of the respective slave backlight controllers are different; and each of the slave backlight controllers is connected to one or more PWM drivers;
the image processor is configured to: based on a received image signal, obtain pieces of partition backlight data according to a predetermined partitioning algorithm and transmit the pieces of partition backlight data to the master backlight controller, wherein the partition backlight data is used to characterize luminance information of a partition image;
the master backlight controller is configured to: receive the pieces of partition backlight data; obtain a global backlight value according to the received pieces of partition backlight data; transmit the global backlight value to the plurality of slave backlight controllers and distribute the partition backlight data of the corresponding extended partitions of the respective slave backlight controllers to the respective slave backlight controllers, wherein the global backlight value is used to characterize overall luminance information of the image signal;
each of the plurality of slave backlight controllers is configured to: receive the global backlight value distributed by the master backlight controller and the partition backlight data of the corresponding extended partition; determine, according to the global backlight value and a preset mapping relationship, a peak gain coefficient mapped by the global backlight value; determine, according to the peak gain coefficient and the partition backlight data, gained partition backlight data of the extended partition, and output a control signal according to the gained partition backlight data of the extended partition, wherein the preset mapping relationship is a corresponding relationship between global backlight values and peak gain coefficients; and
the one or more PWM drivers are controlled in parallel by each of the slave backlight controllers, configured to receive the control signal and control backlights of the extended partition corresponding to the slave backlight controller.

2. The backlight luminance control device according to claim 1, wherein the master backlight controller is disposed on a circuit board; and the plurality of slave backlight controllers are disposed respectively on a plurality of circuit boards for which driving circuits are configured.

3. The backlight luminance control device according to claim 2, wherein each of the driving circuits comprises a plurality of PWM drivers.

4. The backlight luminance control device according to claim 1, wherein the master backlight controller is further configured to receive a global dimming signal, obtain adjusted partition backlight data based on the global dimming signal and the pieces of partition backlight data, and output same to the slave backlight controllers.

5. The backlight luminance control device according to claim 1, wherein the master backlight controller is further configured to obtain a preset adjustment coefficient, and transmit the adjustment coefficient to the plurality of slave backlight controllers.

6. The backlight luminance control device according to claim 1, wherein the master backlight controller is further configured to receive a gain adjusting signal, and the gain adjusting signal carries an adjustment coefficient; and
the master backlight controller is further configured to obtain the adjustment coefficient from the gain adjusting signal, and transmit the adjustment coefficient to the plurality of slave backlight controllers.

7. The backlight luminance control device according to claim 5, wherein each of the plurality of slave backlight controllers is further configured to adjust the partition backlight data of the corresponding extended partition based on the adjustment coefficient.

8. The backlight luminance control device according to claim 5, wherein the adjustment coefficient is obtained based on an ambient lightness parameter or an image mode selected by a user.

9. The backlight luminance control device according to claim 1, wherein mapping relationships preset in the plurality of slave backlight controllers are different.

10. The backlight luminance control device according to claim 1, wherein the master backlight controller is configured to receive the pieces of partition backlight data packaged in a first serial data format, and the first serial data format comprises the pieces of partition backlight data and an end of frame used for indicating an end of frame data.

11. The backlight luminance control device according to claim 10, wherein the end of frame is used to represent a checksum of current frame data.

12. The backlight luminance control device according to claim 10, wherein the first serial data format further comprises a start of heading which is before the pieces of partition backlight data and used to indicate a start of frame data.

13. The backlight luminance control device according to claim 12, wherein the first serial data format further comprises a command field between the start of heading and the pieces of partition backlight data.

14. The backlight luminance control device according to claim 13, wherein the command field is used to indicate a driving mode selection.

15. The backlight luminance control device according to claim 10, wherein each of the plurality of slave backlight controllers is configured to receive the partition backlight data of the extended partition packaged in a second serial data format, and the second serial data format comprises the partition backlight data of the extended partition and an end of frame used for indicating an end of frame data.

16. The backlight luminance control device according to claim 15, wherein the second serial data format further comprises: a field indicating the global backlight value and a field indicating the partition backlight data of the extended partition.

17. The backlight luminance control device according to claim 15, wherein the second serial data format further comprises: a field used for indicating the adjustment coefficient.

18. A backlight luminance control method, comprising:
obtaining, by an image processor, pieces of partition backlight data according to a predetermined partitioning algorithm based on a received image signal, and sending the pieces of partition backlight data to a master backlight controller, wherein the partition backlight data is used to characterize luminance information of a partition image;
receiving, by the master backlight controller, the pieces of partition backlight data, and obtaining a global backlight value according to the received pieces of partition backlight data, wherein the global backlight value is used to characterize overall luminance information of the image signal;
sending, by the master backlight controller, the global backlight value to a slave backlight controller, and distributing the partition backlight data of a corresponding extended partition of the slave backlight controller to the slave backlight controller, wherein, the extended partition comprises one or more backlight partitions, corresponding extended partitions of different slave backlight controllers are different;
receiving, by the slave backlight controller, the global backlight value distributed by the master backlight controller and the partition backlight data of the corresponding extended partition; and determining a peak gain coefficient according to the global backlight value and a preset mapping relationship, wherein the preset mapping relationship is a corresponding relationship between global backlight values and peak gain coefficients;
determining, by the slave backlight controller, gained partition backlight data of the extended partition according to the peak gain coefficient and the partition backlight data, and outputting a control signal according to the gained partition backlight data for controlling backlights of the extended partition.

19. An image display device, comprising: a display panel, a backlight assembly, and the backlight luminance control device according to claim 1.
